(19) United States
(12) Patent Application Publication
(10) Pub. No.: US 2016/0088257 A1
(43) Pub. Date: Mar. 24, 2016

(54) MEDICAL CARE PROVIDER TERMINAL, PATIENT TERMINAL, AND VIDEO CALL METHOD THEREOF

(71) Applicant: LG CNS CO., LTD., Seoul (KR)

(72) Inventors: Jee Hyun KIM, Seoul (KR); Young Kook KIM, Seoul (KR); Ki Hwan CHOI, Seoul (KR); Si Young PARK, Seoul (KR); Hyun Jung PARK, Seoul (KR); Young Don HWANG, Seoul (KR)

(21) Appl. No.: 14/494,886

(22) Filed: Sep. 24, 2014

(51) Int. Cl. H04N 7/14

(52) U.S. Cl. CPC H04N 7/147; G06Q 50/24

(57) ABSTRACT

Provided is a medical care provider terminal, a patient terminal and a method for making a video call therebetween. The method may include receiving, at a medical care provider terminal, a video call request from a patient terminal, connecting, at the medical care provider, a video call to the patient terminal, and displaying patient-related information in a first region of a display of the medical care provider terminal and displaying a video call screen in a second region of the display. The video call screen may include a sharing region for sharing with the patient terminal at least one of a first video captured by a camera module connected to the patient terminal, a second video captured by a camera module connected to the medical care provider terminal, the patient-related information, or data input at the medical care provider terminal.

### BACKGROUND

1. Field

The present disclosure relates to a medical care provider terminal for making a video call to a patient terminal, a patient terminal for making a video call to a medical care provider terminal, and a method for making the video call between the medical care provider terminal and the patient terminal.

2. Background

Telemedicine is generally defined as any activity for transmitting medical information and medical service to a place at a long distance by using an interactive information communication technology. Telemedicine is a system for remotely providing medical information and expert advice to a patient if the patient is far away or too much time is spent for the patient and a medical care provider to meet each other, and has a comprehensive concept including not only patient diagnosis, but also medical administration, medical education, medical consultation, and medical treatment request. In other words, telemedicine is a collective term for technologies for exchanging various types of data, such as medical images, videos, and patient's records, and transferring medical services, by using computers and data communication technologies.

In order to most efficiently perform telemedicine, a patient and a medical care provider may make a video call by using terminals, such as computers. The medical care provider may treat a disease of the patient via an image and voice of the patient, and the patient may become aware of precautions on managing the disease and an improvement in the disease via an image and voice of the medical care provider.

According to development of a telemedicine system, a method of efficiently making a video call between a patent and a medical care provider is required.

### BRIEF DESCRIPTION OF THE DRAWINGS

The embodiments will be described in detail with reference to the following drawings in which like reference numerals refer to like elements wherein:

FIG. 1 is a diagram of a video call system including a patient terminal and a medical care provider terminal, according to an embodiment of the present disclosure;

FIG. 2 is a flowchart illustrating a video call method of a patient terminal, according to an embodiment of the present disclosure;

FIG. 3 is an exemplary diagram illustrating video call schedule information displayed on a display of a patient terminal;

FIG. 4 is an exemplary diagram illustrating notification information displayed on a display of a patient terminal;

FIG. 5 is an exemplary diagram illustrating a video call screen displayed on a display of a patient terminal;

FIG. 6 is a block diagram of a patient terminal according to an embodiment of the present disclosure;

FIG. 7 is a flowchart illustrating a video call method of a medical care provider terminal, according to an embodiment of the present disclosure;

FIG. 8 is an exemplary diagram illustrating patient-related information displayed on a display of a medical care provider terminal;

FIG. 9 is an exemplary diagram illustrating patient-related information and a video call screen, which are displayed on a display of a medical care provider terminal;

FIG. 10 is an exemplary diagram illustrating patient-related information and a video call screen, which are displayed on a display of a medical care provider terminal, when an input for sharing the patient-related information is received from a medical care provider;

FIG. 11 is an exemplary diagram illustrating patient-related information and a video call screen, which are displayed on a display of a medical care provider terminal, when an input for sharing a whiteboard is received from a medical care provider;

FIG. 12 is an exemplary diagram illustrating patient-related information and a video call screen, which are displayed on a display of a medical care provider terminal, when an input for sharing an image template including a body image is received from a medical care provider;

FIG. 13 is an exemplary diagram illustrating patient-related information and a video call screen, which are displayed on a display of a medical care provider terminal; and

FIG. 14 is a block diagram of a medical care provider terminal, according to an embodiment of the present disclosure.

### DETAILED DESCRIPTION

Hereinafter, exemplary embodiments of the present disclosure will be described in detail with reference to the accompanying drawings. While the present disclosure will be described in conjunction with exemplary embodiments thereof, it is to be understood that the present description is not intended to limit the present disclosure to those exemplary embodiments. On the contrary, the present disclosure is intended to cover not only the exemplary embodiments, but also various alternatives, modifications, equivalents and other embodiments that may be included within the spirit and scope of the present disclosure as defined by the appended claims.

According to exemplary embodiments of the present disclosure, the word “unit” may refer to a software component or hardware component such as an FPGA or ASIC capable of carrying out a function or an operation. However, “unit” is not limited to hardware or software. A unit may be configured so as to reside in an addressable storage medium or to drive one or more processors. Units may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose large components and units, or further divided into units along with other components.

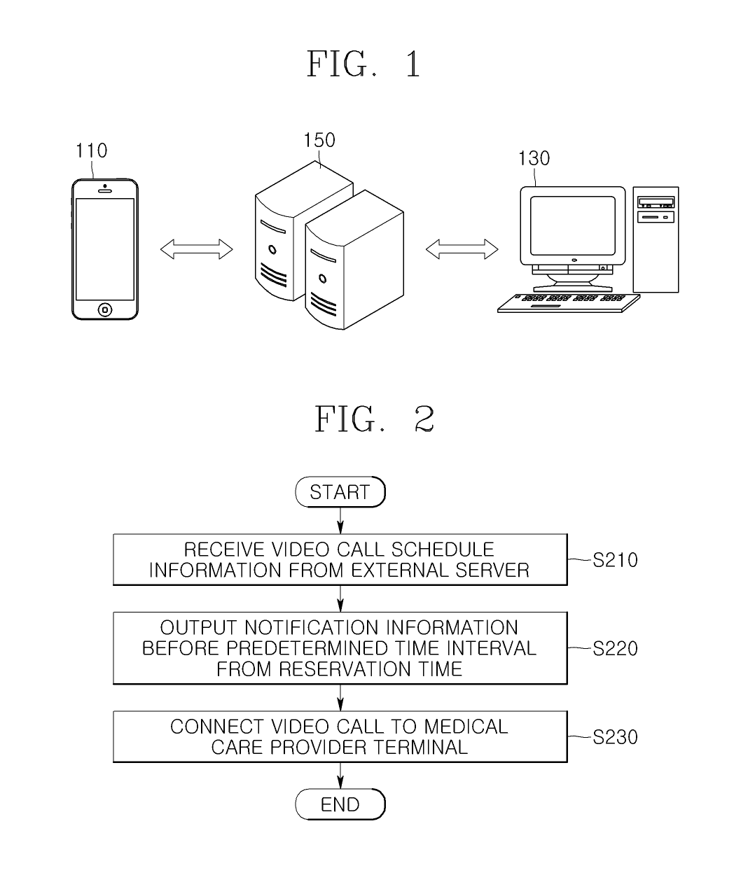

FIG. 1 is a diagram of a video call system including a patient terminal 110 and a medical care provider terminal 130, according to an embodiment of the present disclosure. Referring to FIG. 1, the video call system may include the patient terminal 110, the medical care provider terminal 130, and a server 150.

The patient terminal 110 may be a terminal used by a patient, and may be any one of various terminals, such as a smart phone, a desktop computer, a laptop, a personal digital assistant (PDA), and a tablet personal computer (PC), or another appropriate type of device for communication.

The medical care provider terminal 130 may be a terminal used by a medical expert, such as a doctor, a caregiver, or a nurse, and may be any one of various terminals, such as a smart phone, a desktop computer, a laptop, a PDA, a tablet PC, or another appropriate type of device for communication.

The server 150 may intermediate a video call between the patient terminal 110 and the medical care provider terminal 130. The server 150 may transmit voice data, video data, and still image data received from one of the patient terminal 110 and the medical care provider terminal 130 to the other. According to an embodiment, the patient terminal 110 and the medical care provider terminal 130 may directly make a video call one-on-one without having to use the server 150.

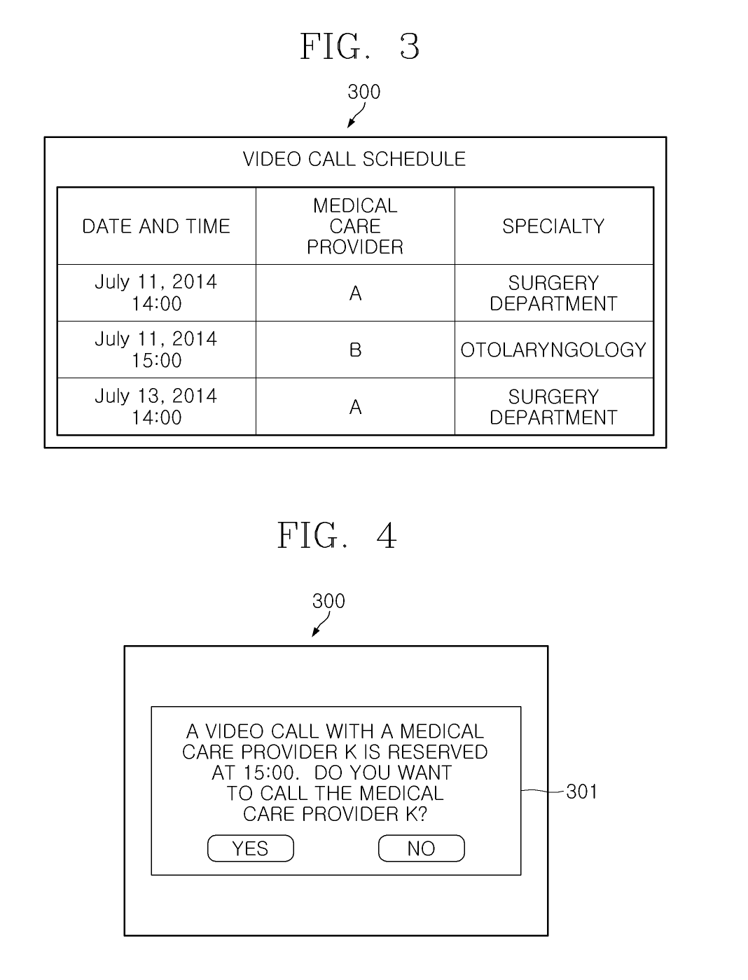

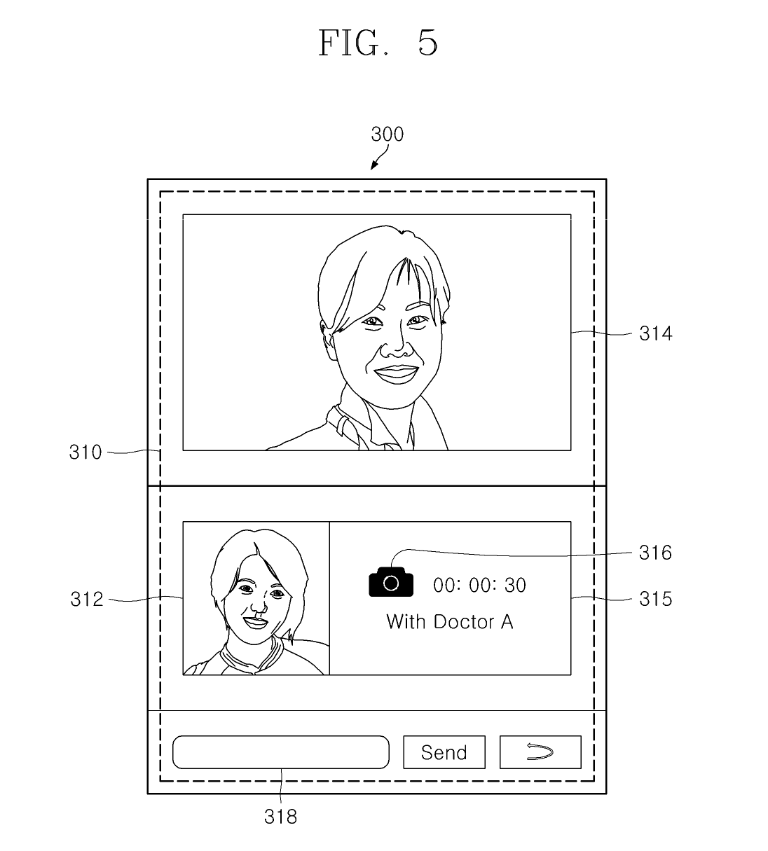

Hereinafter, detailed operations of the patient terminal 110 will be described with reference to FIGS. 2 to 5. FIG. 2 is a flowchart illustrating a video call method of the patient terminal 110, according to an embodiment of the present disclosure. FIG. 3 is an exemplary diagram illustrating video call schedule information displayed on a display of the patient terminal. FIG. 4 is an exemplary diagram illustrating notification information displayed on the display of the patient terminal. Moreover, FIG. 5 is an exemplary diagram illustrating a video call screen displayed on the display of the patient terminal.

Referring to FIG. 1, in operation S210, the patient terminal 110 may receive video call schedule information of a patient from an external server, for example, the server 150. The video call schedule information may include information about when a video call of the patient is scheduled, and may be changed by the medical care provider terminal 130. When the video call schedule information stored in the server 150 is changed by the medical care provider terminal 130, the patient terminal 110 may receive the changed video call schedule information from the server 150.

As shown in FIG. 3, the video call schedule information may be displayed on display 300 and may include the date and time when the video call is scheduled, a medical care provider who is in charge of the video call, and a specialty of the medical care provider. The video call schedule information shown in FIG. 3 is merely an example, and may include more or less information. For example, the video call schedule information may only include the date and time when a video call is scheduled or may include additional information not shown such as contact information, address, insurance information, or the like.

In operation S220, the patient terminal 110 may output notification information before a predetermined time interval from a reservation time included in the video call schedule information. The patient terminal 110 may output the notification information via an output device, such as a display, a speaker, or a printer.

The predetermined time interval may be pre-set in the patient terminal 110 or may be changed by the patient. For example, if a video call is scheduled on July 11th at 14:00, the patient terminal 110 may output notification information on July 11th at 13:50 notifying the patient beforehand that the video call is scheduled.

The notification information may be a notification window 301 displayed on display 300. The patient terminal 110 may output the notification information shown in FIG. 4 through the display 300, and the patient may click Yes' from the notification information to connect a video call to the medical care provider terminal 130.

In operation S230, when the patient approves the video call according to the notification information, the patient terminal 110 may connect the video call to the medical care provider terminal 130.

When the patient terminal 110 connects the video call to the medical care provider terminal 130, a video call screen may be displayed on the patient terminal 110. Referring to FIG. 5, the video call screen 310 displayed on the display 300 of the patient terminal 110 may include a first video 312 captured by a camera module connected to the patient terminal 110 and a second video 314 captured by a camera module connected to the medical care provider terminal 130. The video call screen 310 may further include a chat input window 318, and the patient may chat with the medical care provider through the chat input window 318.

Also, referring to FIG. 5, the video call screen 310 may further include a still image capturing menu 316. The still image capturing menu 316 may be displayed in the image region 315. When the patient selects the still image capturing menu 316, the camera module connected to the patient terminal 110 may capture a still image of the patient. The patient terminal 110 may transmit the still image of the patient to the medical care provider terminal 130 or the server 150 such that the medical care provider can check the still image of the patient. The medical care provider may request the patient to transmit a still image of a troubled region, or the patient may capture the troubled region by selecting the still image capturing menu 316 and transmit the captured troubled region to the medical care provider, so that the medical care provider may visually examine the patient. The still image may also be taken prior to the video call and retrieved from a storage device for transmitting to the medical care provider terminal during the video call. In this case, an option may be provided to the user for retrieving a stored image when the still image capturing menu 316 is selected. It should be appreciated that the still image capturing menu 316 may also be used to access previously stored video.

In FIG. 5, the still image capturing menu 316 may be included in the video call screen 310, but alternatively, the patient may capture a still image via any one of various inputs for example, a voice input, a keyboard input, a mouse input, and a button input included in the patient terminal 110.

The video call screen 310 may include a whiteboard sharing request menu. When the patient selects the whiteboard sharing request menu, the patient terminal 110 may share a whiteboard with the medical care provider by including the whiteboard in the video call screen 310. Also, the patient terminal 110 may provide a writing function on the whiteboard, and share, with the medical care provider terminal 130, data input to the whiteboard by the patient, and thus the patient and the medical care provider may communicate with each other. A whiteboard screen may be displayed on the image region 315 or on any predetermined region or the entire region of the video call screen 310.

Meanwhile, while the patient terminal 110 was previously described in reference to FIG. 2 as being able to connect a video call to the medical care provider terminal 130 when the video call is scheduled, the present disclosure is not limited thereto. For example, even when a video call is not scheduled, the patient may select a medical care provider for a video call from a list of medical care providers displayed on the display 300 of the patient terminal 110, and the patient terminal 110 may request the medical care provider terminal 130 of the selected medical care provider for a video call.

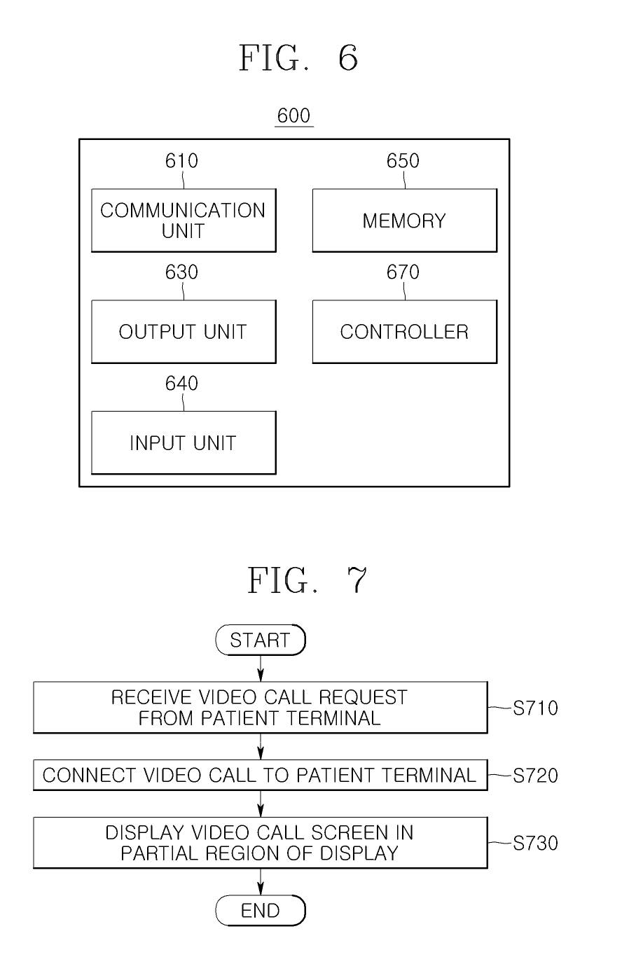

FIG. 6 is a block diagram of a patient terminal 600 according to an embodiment of the present disclosure. The patient terminal 600 may include a communication unit 610, an output unit 630, an input unit 640, a memory 650, and a controller 670. The controller 670 may include at least one processor, and may be driven under control of at least one program stored in the memory 650. Meanwhile, at least one of the communication unit 610, the output unit 630, the input unit 640, and the memory 650 may be realized in hardware, or some or all of the communication unit 610, the output unit 630, the input unit 640, and the memory 650 may be realized in at least one program.

The communication unit 610 may communicate with the medical care provider terminal 130 or the server 150. For example, the communication unit 610 may request the server 150 to transmit video call schedule information of a patient, and in response, receive the video call schedule information from the server 150. When the video call schedule information stored in the server 150 is changed by the medical care provider terminal 130, the communication unit 610 may receive the changed video call schedule information from the server 150. Also, the communication unit 610 may send a request to the medical care provider terminal 130 of a medical care provider selected by the patient for a video call.

The output unit 630 may output notification information before a predetermined time interval from a reservation time included in the video call schedule information so as to notify the patient that a video call is reserved. The output unit 630 may include any one of various output devices, such as a display, a speaker, a printer, or another appropriate type of output device. Also, when the patient terminal 600 connects a video call to the medical care provider terminal 130, the output unit 630 may display a video call screen on the display.

The memory 650 may store the video call schedule information received from the server 150. Also, the memory 650 may store a list of medical care providers for a video call, and connection identification (ID) information of the medical care provider terminals 130 of the medical care providers in the list. The connection ID information may include information for specifying each of the medical care provider terminals 130, such as a phone number or an internet protocol (IP) number. The controller 670 may control operations of each of the communication unit 610, the output unit 630, the input unit 640, and the memory 650.

The input unit 640 (also referred to herein as an input receiver) may receive a predetermined input from the patient. The input receiver 640 may be any one of various input devices capable of receiving a predetermined input from the patient, such as a mouse, a keyboard, and a touch screen, a microphone, or another appropriate type of input device.

When the input receiver 640 receives an input for selecting a medical care provider with whom the patient wants to make a video call, the communication unit 610 may request the medical care provider terminal 130 of the selected medical care provider for a video call. Also, when the input receiver 640 receives an input for capturing a still image from the patient, a camera module connected to the patient terminal 600 may capture a still image of the patient and the communication unit 610 may transmit the still image of the patient to the medical care provider terminal 130 or the server 150. Also, when the input receiver 640 receives an input for sharing a whiteboard from the patient, the output unit 630 may include a whiteboard screen to the video call screen, and share data input to the whiteboard screen by the patient with the medical care provider terminal 130.

Hereinafter, detailed operations of the medical care provider terminal 130 of FIG. 1 will be described in detail. FIG. 7 is a flowchart illustrating a video call method of the medical care provider terminal 130, according to an embodiment of the present disclosure.

In operation S710, the medical care provider terminal 130 may receive a video call request from the patient terminal 110. In operation S720, when a medical care provider approves the video call request, the medical care provider terminal 130 may connect a video call to the patient terminal 110.

In operation S730, the medical care provider terminal 130 may display a video call screen in a partial region of a display of the medical care provider terminal 130, while patient-related information is displayed on the display. The medical care provider terminal 130 may generate the patient-related information via a predetermined program. The predetermined program may include an electronic chart program.

A video call screen may include a sharing region for sharing, with a patient terminal, at least one of a first video captured by a camera module connected to the patient terminal, a second video captured by a camera module connected to a medical care provider terminal, patient-related information, or data input by a medical care provider.

When the video call is connected to the patient terminal 110, the medical care provider terminal 130 may reduce a region of the display of the medical care provider terminal 130 which displays the patient-related information, and display the video call screen in a partial region of the display. In other words, when the video call is connected to the patient terminal 110 while the medical care provider terminal 130 is displaying the patient-related information on an entire region or most of the display, the medical care provider terminal 130 may automatically reduce the region where the patient-related information is being displayed, and may display the video call screen in the partial region of the display thus formed.

When the medical care provider terminal 130 connects the video call to the patient terminal 110, the medical care provider terminal 130 may not separately pop-up a page for displaying the video call screen, but may display the video call screen after embedding the video call screen in a predetermined program for displaying the patient-related information. For example, the video call screen may be embedded in an application screen or window for the application program that manages patient-related information. Accordingly, the medical care provider may be able to use functions of the predetermined program for displaying the patient-related information even while talking to the patient.

A user interface (UI) may be provided that allows adjustment to the displayed arrangement of user's windows. For example, Flex may be used as a user interface (UI) technology development language in which a layout may be adjusted in ratios. Hence, even if a video call screen is displayed on a display, a width of a predetermined program, such as an electronic chart program, may be automatically adjusted, and thus, functions of the predetermined program may not be affected. Also, all functions of the predetermined program may be used even during the video call by displaying the video call screen on a screen in the same page as the predetermined program by, for example, calling an Active-X object within a frame of iFrame of Flex.

If the video call is connected to the patient terminal 110 while the patient-related information is not displayed on the display of the medical care provider terminal 130, the medical care provider terminal 130 may execute the predetermined program so as to display the patient-related information of the patient and the video call screen respectively in a first region and a second region of the display.

A sharing region included in a video call screen may display information to be shared with a patient terminal, wherein the sharing region may display, according to selection of a medical care provider, at least one of a first video captured by a camera module connected to the patient terminal, a second video captured by a camera module connected to a medical care provider terminal, patient-related information, or data input by the medical care provider.

According to a general video call method, telemedicine may be performed only via video call screens on which videos of a patient and a medical care provider are displayed. However, according to a video call method of an embodiment of the present disclosure, a medical care provider may talk to a patient via a video call while looking at an electronic chart displayed on a video call screen embedded in an electronic chart program. For example, the video call screen is embedded in an application screen or window of the electronic chart program so that the video call screen may be seamlessly displayed together with the patient chart. Thus, telemedicine may be more accurately and effectively be performed.

Meanwhile, the medical care provider terminal 130 may be configured to connect the video call to the patient terminal 110 only when the video call request is received from the patient terminal 110, and according to one or more embodiments, when the medical care provider selects a patient for a video call from a list of patients displayed on the medical care provider terminal 130, the medical care provider terminal 130 may request the patient terminal 110 of the selected patient for the video call.

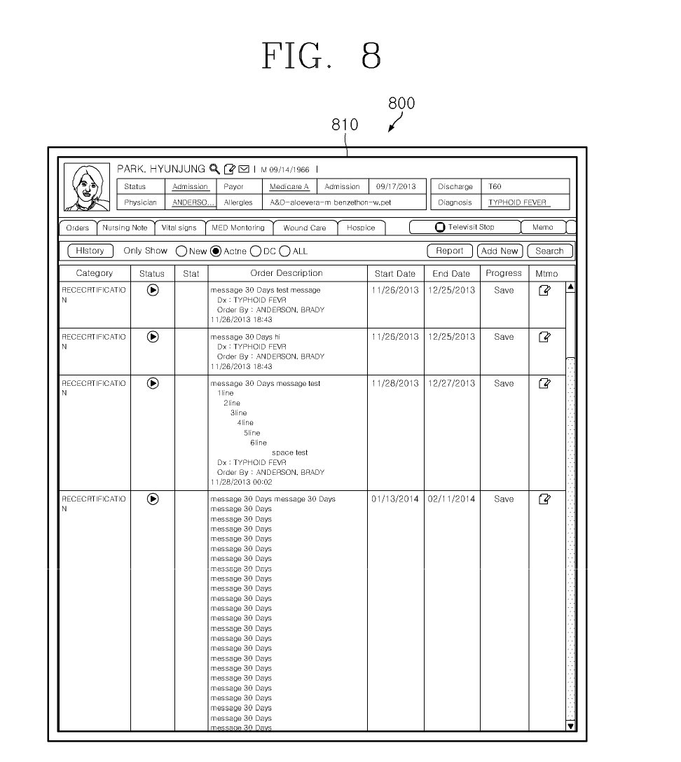

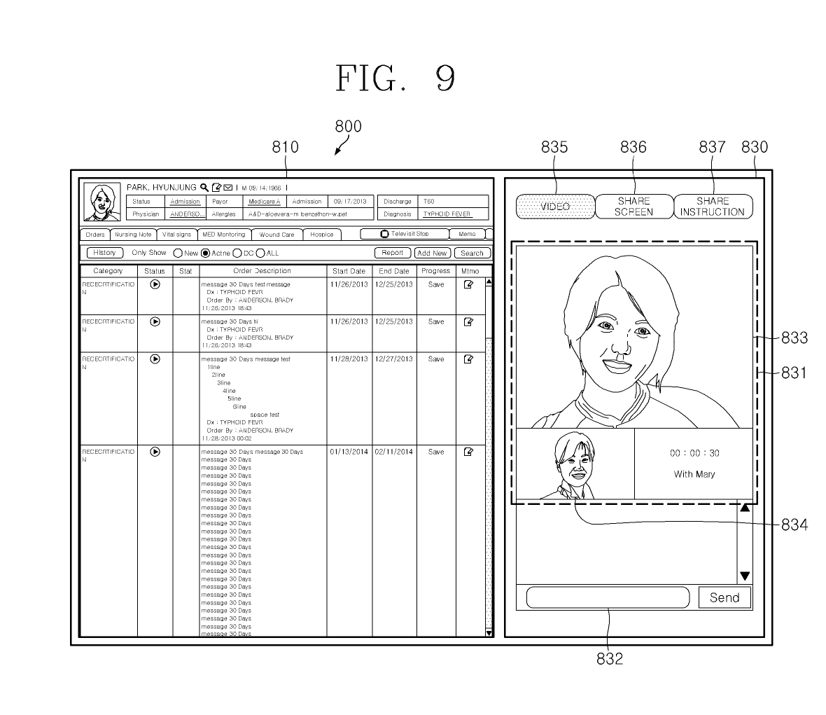

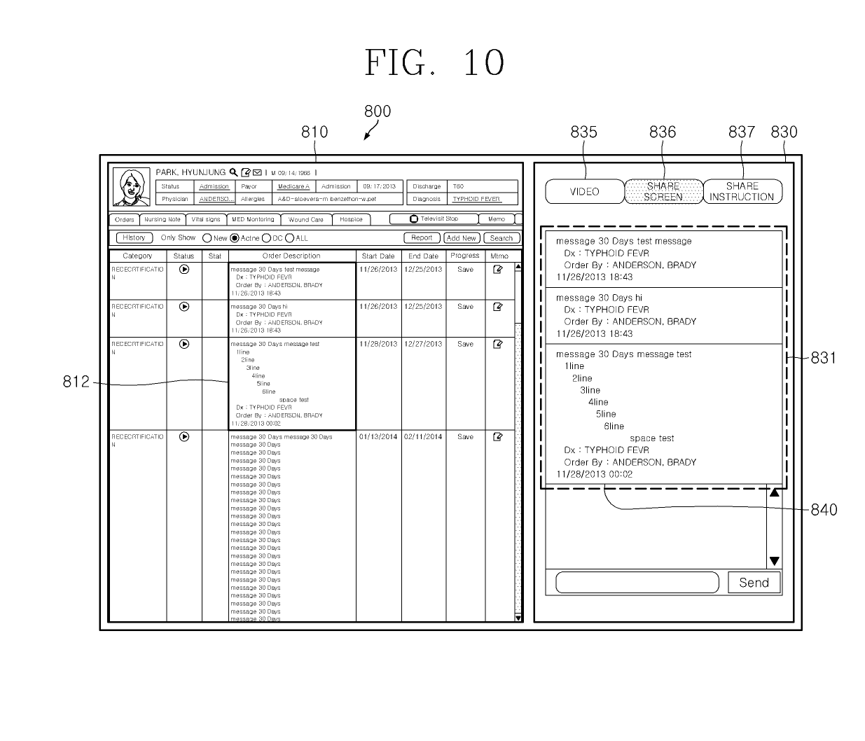

FIG. 8 is an exemplary diagram illustrating patient-related information displayed on a display of the medical care provider terminal, and FIG. 9 is an exemplary diagram illustrating the patient-related information and a video call screen, which are displayed on the display of the medical care provider terminal.

The patient-related information 810 of FIG. 8 may be displayed on a screen on the display 800 of the medical care provider via a predetermined program, such as an electronic chart program, and may include various types of information related to a patient, such as prescription information, nursing information, and vital sign information.

As shown in FIG. 9, when a video call is connected to the patient terminal 110, the medical care provider terminal 130 may reduce a region where the patient-related information 810 is displayed, and display the video call screen 830 in a partial region of the display 800.

The video call screen 830 may display, in a sharing region 831, at least one of a first video 833 captured by a camera module connected to the patient terminal 110 and a second video 834 captured by a camera module connected to the medical care provider terminal 130. Also, the medical care provider may chat with the patient by inputting text through a text input window 832 included in the video call screen 830.

The video call screen 830 of FIG. 9 may include a menu that includes a video menu item 835, a screen sharing menu item 836, and an instruction sharing menu item 837. Each menu item may be a button, a tab in a tab menu, or another appropriate type of input object. When the video menu item 835 is selected by the medical care provider, at least one of the first video 833 and the second video 834 may be displayed in the sharing region 831 of the video call screen 830, as illustrated in FIG. 9.

FIG. 10 is an exemplary diagram illustrating the patient-related information 810 and the video call screen 830, which may be displayed on the display 800 of the medical care provider terminal 130 when an input for sharing the patient-related information 810 is received from the medical care provider.

When the medical care provider selects the screen sharing menu item 836 from among the video menu item 835, the screen sharing menu item 836, and the instruction sharing menu item 837 as illustrated in FIG. 10, the medical care provider terminal 130 may display, on the display 800, a selection frame 812 for selecting a region to be shared. The medical care provider may adjust the selection frame 812 to select a region to be shared with the patient from the region where the patient-related information 810 is displayed.

The medical care provider terminal 130 may display a screen 840 of the region selected by the medical care provider in the sharing region 831, instead of at least one of the first video 833 and the second video 834 displayed in the sharing region 831 of the video call screen 830. The medical care provider terminal 130 may provide a writing function on the screen 840 for the selected region, and the medical care provider may use the writing function to further easily transmit, to the patient, status information of the patient. For example, the writing function may allow annotations to be shared with the patient on the patient-related information 810 displayed in the screen 830.

Here, the video call with the patient may be maintained even if the selection is changed from the video menu item 835 to the screen sharing menu item 836. In other words, when the medical care provider changes the screen sharing menu item 836 back to the video menu item 835, at least one of the first video 833 and the second video 834 may be displayed in the sharing region 831.

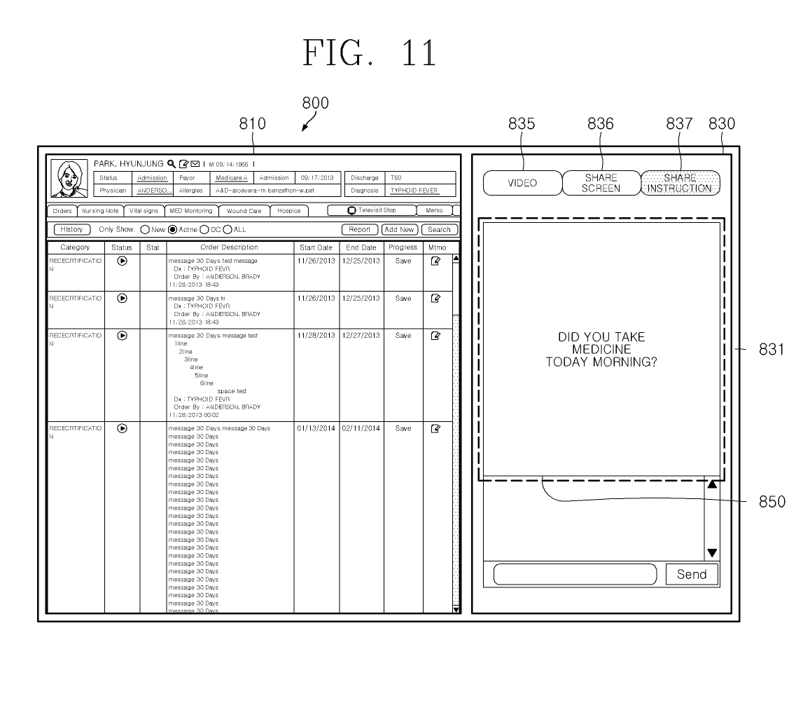

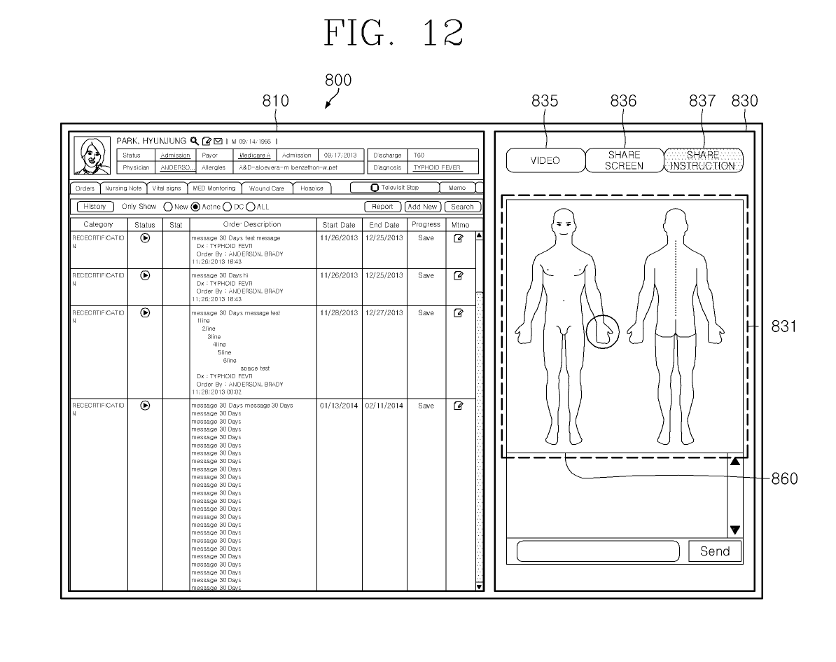

FIG. 11 is an exemplary diagram illustrating the patient-related information and the video call screen, which may be displayed on the display 800 of the medical care provider terminal 130 when an input for sharing a whiteboard 850 is received from the medical care provider.

As shown in FIG. 11, when the medical care provider selects the instruction sharing menu item 837, the medical care provider terminal 130 may display the whiteboard 850 in the sharing region 831 of the video call screen 830. The medical care provider terminal 130 may provide a writing function on the whiteboard 850 displayed in the sharing region 831, and the medical care provider terminal 130 may share with the patient terminal 110 data input through the whiteboard 850.

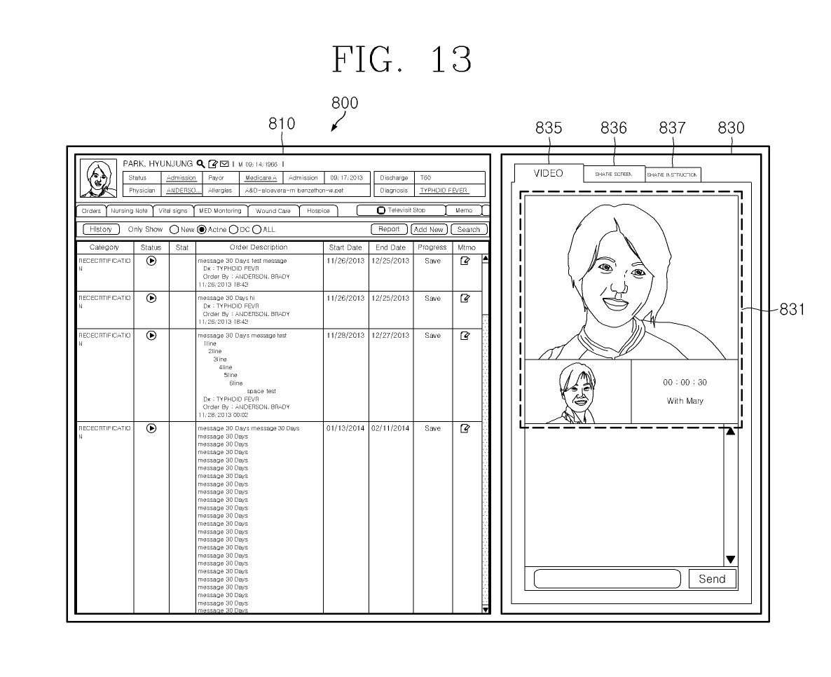

FIG. 12 is an exemplary diagram illustrating the patient-related information and the video call screen which may be displayed on the display of the medical care provider terminal 130 when an input for sharing an image template including a body image is received from the medical care provider.

When the medical care provider selects an image template 860 including the body image while the instruction sharing menu item 837 is selected, the medical care provider terminal 130 may include the image template 860 to the sharing region 831 of the video call screen 830. The medical care provider terminal 130 may provide a writing function on the image template 860, and thus, the medical care provider may effectively provide, to the patient, information related to patient's condition.

Meanwhile, while it has been described that the medical care provider uses any one of the video menu item 835, the screen sharing menu item 836, and the instruction sharing menu item 837 of FIGS. 9 to 12 at the medical care provider terminal 130 to execute a corresponding function, the input items 835, 836 and 837 included in the video call screen 830 are merely examples and the present disclosure is not limited to such methods of input. For example, the medical care provider may control functions of the medical care provider terminal 130 and content displayed in the sharing region 831 by using any one of various inputs, for example, a physical button included in the medical care provider terminal 130, a voice input, a keyboard input, a mouse input, or another appropriate type of input.

FIG. 13 is an exemplary diagram illustrating the patient-related information and the video call screen which may be displayed on the display 800 of the medical care provider terminal 130. As shown in FIGS. 9 to 12, a function corresponding to a menu item selected from among the video menu item 835, the screen sharing menu item 836, and the instruction sharing menu item 837 displayed on the display 800 may be displayed in one sharing region 831. However, according to one or more embodiments, as shown in FIG. 13, the video menu item 835, the screen sharing menu item 836, and the instruction sharing menu item 837 may be displayed on separate layers. For example, the menu items 835, 836, 837 may be the menu items representing a tab menu. Here, the sharing regions 831 of the video menu item 835, the screen sharing menu item 836, and the instruction sharing menu item 837 may be displayed on the display 800 while overlapping each other.

When any tab is selected among the video tab 835, the screen sharing tab 836, and the instruction sharing tab 837, a layer corresponding to the selected tab may be activated and displayed in the foreground, and content corresponding to the selected tab may be displayed in the sharing region 831.

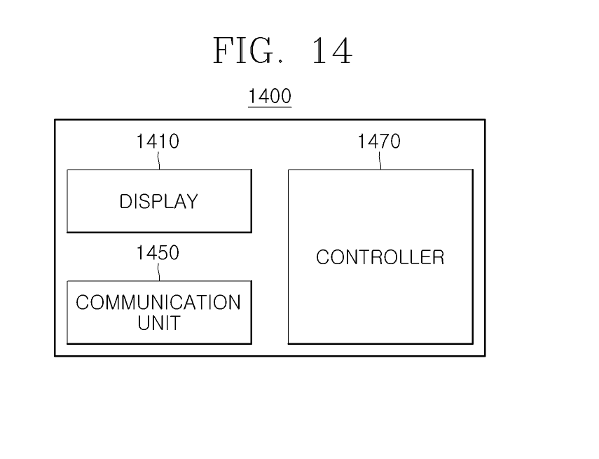

FIG. 14 is a block diagram of a medical care provider terminal, according to an embodiment of the present disclosure. The medical care provider terminal 1400 may include a display 1410, a communication unit 1450, and a controller 1470. The controller 1470 may be formed of at least one microprocessor, and may be driven under control of at least one program stored in a memory. At least one of the display 1410 and the communication unit 1450 may be realized in hardware, or some or all of the display 1410 and the communication unit 1450 may be realized in at least one program.

The display 1410 may display predetermined information on a screen, and for example, the display 1410 may include a cathode-ray tube (CRT) display, liquid crystal display (LCD), a plasma display panel (PDP) display, an organic light-emitting display (OLED), a field emission display (FED), an LED, a vacuum fluorescent display (VFD), digital light processing (DLP) display, a flat panel display (FPD), a 3-dimensional (3D) display, a transparent display, or another appropriate type of display device.

The communication unit 1450 may receive a video call request from the patient terminal 110, and may connect a video call to the patient terminal 110. The communication unit 1450 may transmit video data, voice data, or the like from the medical care provider terminal 1400 to the server 150, and receive video data, voice data, or the like from the server 150. When an input for selecting a patient for a video call is received from the medical care provider, the communication unit 1450 may request the patient terminal 110 of the selected patient for a video call.

The controller 1470 may control operations of the display 1410 and the communication unit 1450. When a video call is connected to the patient terminal 110, the controller 1470 may display a video call screen in a partial region of the display 1410 where patient-related information is displayed. For example, when a video call is connected to the patient terminal 110, the controller 1470 may reduce a region of the display 1410 where the patient-related information is displayed, and display the video call screen in the partial region of the display 1410. A video call screen may include a sharing region for sharing, with a patient terminal, at least one of a first video captured by a camera module connected to the patient terminal, a second video captured by a camera module connected to a medical care provider terminal, patient-related information, and data input by a medical care provider.

The medical care provider terminal 1400 according to an embodiment of the present disclosure may further include an input receiver (also referred to herein as an input receiver) that receives a predetermined input of a user. The input receiver may include any one of various input devices, such as a touch screen, a speaker, and a printer.

When an input for sharing patient-related information is received from the medical care provider through the input receiver, the controller 1470 may display, in the sharing region of the video call screen, a region selected by the medical care provider from the region where the patient-related information is displayed, and share the selected region with the patient terminal 110. The controller 1470 may display the selected region in the sharing region instead of content that was displayed in the sharing region.

Also, when a still image of the patient is captured by a camera module connected to the patient terminal 110, the controller 1470 may display the captured still image on the display 1410. Also, when an input for sharing an image template including a body image is received from the medical care provider, the controller 1470 may share the image template with the patient terminal 110 through the sharing region. Alternatively, when an input for sharing a whiteboard is received from the medical care provider, the controller 1470 may display the whiteboard in the sharing region and share, with the patient terminal 110, data input to the whiteboard by the medical care provider.

As broadly described and embodied herein, an improved medical care provider terminal, patient terminal, and method for making a video call therebetween is provided herein. One or more embodiments of the present disclosure may include a medical care provider terminal, a patient terminal, and a video call method thereof, wherein a video call may be conveniently connected between the patient terminal and the medical care provider terminal.

One or more embodiments of the present disclosure may include a medical care provider terminal, a patient terminal, and a video call method thereof, wherein a patient may easily recognize his/her disease information.

One or more embodiments of the present disclosure may include a medical care provider terminal, a patient terminal, and a video call method thereof, wherein a medical care provider may easily diagnose and instruct a patient.

According to one or more embodiments of the present disclosure, a video call method of a medical care provider terminal, may include: receiving a video call request from a patient terminal; connecting a video call to the patient terminal; and displaying a video call screen in a partial region of a display of the medical care provider terminal, the display displaying patient-related information, wherein the video call screen includes a sharing region for sharing, with the patient terminal, at least one of a first video captured by a camera module connected to the patient terminal, a second video captured by a camera module connected to the medical care provider terminal, the patient-related information, and data input by a medical care provider.

According to one or more embodiments of the present disclosure, a video call method of a patient terminal, may include: receiving video call schedule information of a patient from an external server; outputting notification information before a predetermined time interval from a reservation time included in the video call schedule information; and when the patient approves a video call according to the output notification information, connecting the video call to a medical care provider terminal.

According to one or more embodiments of the present disclosure, a medical care provider terminal for making a video call to a patient terminal, may include: a display; a communication unit that receives a video call request from the patient terminal and connects a video call to the patient terminal; and a controller that displays a video call screen in a partial region of the display displaying patient-related information, wherein the video call screen includes a sharing region for sharing, with the patient terminal, at least one of a first video captured by a camera module connected to the patient terminal, a second video captured by a camera module connected to the medical care provider terminal, the patient-related information, and data input by a medical care provider.

According to one or more embodiments of the present disclosure, a patient terminal for making a video call to a medical care provider terminal, may include: a communication unit that receives video call schedule information of the patient terminal from an external server; and an output unit that outputs notification information before a predetermined time interval from a reservation time included in the video call schedule information, wherein, when a patient approves a video call according to the output notification information, the communication unit connects the video call to the medical care provider terminal.

Meanwhile, the embodiments of the present disclosure described above may be drafted into computer-executable programs, and may be embodied within a conventional digital computer for operating the program using a computer-readable recording medium.

The computer-readable recording medium may include storage media such as a magnetic storage medium (e.g., ROMs, floppy disks, hard disks, etc.), an optically readable medium (e.g., CD ROMs, DVDs, etc.), and a carrier wave (e.g., transmission via the internet).

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for making a video call in a medical care provider terminal, the method comprising:
receiving, at a medical care provider terminal, a video call request from a patient terminal;
connecting, at the medical care provider terminal, a video call to the patient terminal; and
displaying patient-related information in a first region of a display of the medical care provider terminal and displaying a video call screen in a second region of the display,
wherein the video call screen includes a sharing region for sharing with the patient terminal at least one of a first video captured by a camera module connected to the patient terminal, a second video captured by a camera module connected to the medical care provider terminal, the patient-related information, or data input at the medical care provider terminal.

2. The method of claim 1, wherein the patient-related information is displayed in an application window for an application that manages patient-related information, and the video call screen is embedded in the application window of the application.

3. The method of claim 1, wherein the displaying the video call screen includes, when the video call is connected to the patient terminal, reducing a size of the first region of the display of the medical care provider terminal that displays the patient-related information to accommodate the second region, and displaying the video call screen in the second region.

4. The method of claim 1, further comprising:
receiving an input for sharing the patient-related information from the medical care provider terminal; and
sharing the patient-related information with the patient terminal by displaying, in the sharing region, a region selected by the medical care provider from a region displaying the patient-related information.

5. The method of claim 1, further comprising, when an input for sharing an image is received at the medical care provider terminal, sharing the image with the patient terminal by displaying the image in the sharing region, wherein the image is a template that includes an image of a body.

6. The method of claim 1, further comprising:
receiving an input for sharing a whiteboard at the medical care provider terminal;
displaying the whiteboard in the sharing region; and
sharing, with the patient terminal, data input to the whiteboard at the medical care provider terminal.

7. The method of claim 1, further comprising changing content displayed in the sharing region to at least one of the first video, the second video, the patient-related information, or the data input at the medical care provider terminal, according to a user selection with respect to one of a plurality of menu tabs displayed on the display.

8. The method of claim 1, further comprising:
receiving, at the medical care provider terminal, an input for selecting a patient for the video call; and
requesting the patient terminal to initiate the video call according to the input.

9. The method of claim 1, further comprising, when a still image of a patient is captured by the camera module connected to the patient terminal, displaying the captured still image on the display.

10. A computer-readable recording medium having recorded thereon a program for executing the method for a video call of claim 1.

11. A medical care provider terminal for making a video call to a patient terminal, the medical care provider terminal comprising:
a display;
a communication unit that receives a video call request from the patient terminal and connects a video call to the patient terminal; and
a controller that controls to display patient-related information in a first region of the display and to display a video call screen in a second region of the display,
wherein the video call screen includes a sharing region for sharing with the patient terminal at least one of a first video captured by a camera module connected to the patient terminal, a second video captured by a camera module connected to the medical care provider terminal, the patient-related information, or data input at the medical care provider terminal.

12. The medical care provider terminal of claim 11, wherein the patient-related information is displayed in an application window for an application that manages patient-related information, and the video call screen is embedded in the application window of the application.

13. The medical care provider terminal of claim 11, wherein, when the video call is connected to the patient terminal, the controller controls to reduce a size of the first region of the display of the medical care provider terminal that displays the patient-related information to accommodate the second region, and displaying the video call screen in the second region.

14. The medical care provider terminal of claim 11, further comprising an input interface that receives an input for sharing the patient-related information from the medical care provider terminal,
wherein the controller controls to share the patient-related information with the patient terminal by displaying, in the sharing region, a region selected from the patient-related information displayed in the first region.

15. The medical care provider terminal of claim 11, further comprising an input interface that receives an input for sharing a template that includes an image of a body at from the medical care provider terminal,
wherein the controller controls to share the template with the patient terminal by displaying the template in the sharing region.

16. The medical care provider terminal of claim 11, further comprising an input receiver that receives an input for sharing a whiteboard at the medical care provider terminal,
wherein the controller controls to display the whiteboard in the sharing region, and shares, with the patient terminal, data input to the whiteboard at the medical care provider terminal.

17. The medical care provider terminal of claim 11, wherein the controller controls to change content displayed in the sharing region to at least one of the first video, the second video, the patient-related information, or the data input at the medical care provider terminal, according to a user selection with respect to one of a plurality of menu tabs displayed on the display.

18. The medical care provider terminal of claim 11, further comprising an input interface that receives an input for selecting a patient for the video call,
wherein the communication unit is configured to send a request to the patient terminal to initiate the video call according to the input.

19. The medical care provider terminal of claim 11, wherein, when a still image of a patient is captured by the camera module connected to the patient terminal, the controller displays the captured still image on the display.
